(19) United States
(12) Patent Application Publication
(10) Pub. No.: US 2026/0258734 A1
(43) Pub. Date: Sep. 3, 2026

(54) AIRCRAFT PROPULSION SYSTEM WITH TURBINE ENGINE COUPLED TO AN ELECTRIC GENERATOR THE POWER OF WHICH IS LIMITED AS A FUNCTION OF ENGINE SPEED

(71) Applicant: SAFRAN AIRCRAFT ENGINES, Paris (FR)

(72) Inventors: Arnaud Nicolas MOREL, MOISSY-CRAMAYEL (FR); Jean-Baptiste Etienne Bernard LEPRETRE, MOISSY-CRAMAYEL (FR); Amaury Jean OLIVIER, MOISSY-CRAMAYEL (FR)

(73) Assignee: SAFRAN AIRCRAFT ENGINES, Paris (FR)

(21) Appl. No.: 18/879,556

(22) PCT Filed: Jun. 27, 2023
(86) PCT No.: PCT/FR2023/050969

§ 371 Date: Dec. 27, 2024

(30) Foreign Application Priority Data
Jun. 30, 2022 (FR) 2206688

(51) Int. Cl. F01D 15/10

(52) U.S. Cl. CPC F01D 15/10; F05D 2220/323; F05D 2270/02; F05D 2270/3032; F05D 2270/304

(57) ABSTRACT

An aircraft propulsion system including a gas turbine engine with a combustion chamber and an engine spool, the engine spool including a turbine downstream of the combustion chamber, a compressor upstream of the combustion chamber and a transmission shaft; a control system; a member for determining a current engine speed of the engine spool; and a rotary machine for generating electrical power removing mechanical power from the transmission shaft. The control system limits a current electrical power generated by the rotary machine, at least when the engine spool is in the acceleration phase, to a maximum authorized power, the maximum authorized power being a function of the current engine speed before acceleration, and the propulsion system includes a device for determining the current electrical power and the control system establishes the engine speed above an idle speed which is a function of the current electrical power.

### FIELD OF THE INVENTION

This invention relates to an aircraft propulsion system, of the type comprising a gas turbine engine with a combustion chamber and an engine spool, the engine spool including a turbine downstream of the combustion chamber, a compressor upstream of the combustion chamber and a transmission shaft for driving the compressor via the turbine, the propulsion system also comprising a control system, a member for determining a current engine speed of the engine spool and a rotary machine coupled to the transmission shaft for generating electrical power by taking off mechanical power from the transmission shaft.

This invention also relates to a method for controlling an aircraft propulsion system of the aforementioned type.

### TECHNICAL BACKGROUND

Propulsion system of the aforementioned type are known, for example from EP 3 845 750 A1 and U.S. Pat. No. 7,514,810 B2.

On these known systems, the engine idle speed, i.e. the rotational velocity of the engine spool when the aircraft does not need propulsion, is usually single-value and does not depend on the electrical power generated by the rotary machine. The engine idle speed is therefore the same whatever the electrical power generated by the rotary machine.

It is also known that propulsion systems equipping aircraft must, for safety reasons, be able, under any circumstances, to re-establish the majority, typically over 90%, of their full-throttle power within a very short critical time, typically equal to 8 seconds. In particular, this entails that the engine spool of an idling gas turbine engine must be able to reach a substantial percentage of its full-throttle engine speed, i.e. its engine speed when the gas turbine engine is producing its full-throttle thrust, within said critical time. It is therefore advisable to dimension the engine idle speed so as to be able to meet this objective when the engine spool is accelerated to its maximum capacity.

It is also known that the maximum acceleration rate that can be tolerated by the engine spool of a gas turbine engine depends on the resistive torque applied to said engine spool. Specifically, the acceleration rate of the engine spool of a gas turbine engine is a function of the difference between the temperature at the outlet of the combustion chamber during the acceleration phase and the temperature at the outlet of the combustion chamber when the gas turbine engine is in the stabilized speed: the greater the difference in temperature, the greater the acceleration rate. However, this difference cannot be increased at will since the temperature at the outlet of the combustion chamber, for a given engine speed, is capped: the higher the temperature at the outlet of the combustion chamber, the lower the flow rate at the outlet of the compressor, to the extent that, above a threshold temperature, the outlet flow rate is insufficient and the compressor stalls. The maximum acceleration rate is therefore a function of the difference between this threshold temperature and the temperature at the stabilized speed. However, for a given engine speed, the greater the applied resistive torque, the higher the temperature in the stabilized speed, and therefore the smaller the difference between the threshold temperature and the temperature at the stabilized speed, and hence the maximum acceleration rate.

It will therefore be easily understood that, in the propulsion systems of the aforementioned type, the maximum acceleration rate that can be tolerated by the engine spool decreases as the electrical power generated by the rotary machine increases.

Thus, in known propulsion systems, the maximum acceleration rate permitted in engine idle speed is at the most equal to the maximum acceleration rate that can be tolerated by the engine spool when the electrical power generated the rotary machine is at a maximum. Specifically, the engine idle speed being the same whatever the electrical power generated by the rotary machine, any other value of the maximum authorized acceleration rate would lead to the stalling of the compressor when the electrical power generated by the rotary machine is approaching its maximum.

In known propulsion systems, the engine idle speed is therefore set to a value such that, by applying the maximum acceleration rate that can be tolerated by the engine spool when the electrical power generated by the rotary machine is at a maximum, the propulsion system manages to re-establish most of its maximum thrust within the critical time.

However, these known systems do not provide complete satisfaction. Specifically, with the improvement of the thrust produced by airplane propulsion systems and the reduction of the drag of these latters, the ratio of drag to thrust in engine idle speed tends to decrease. However, it is necessary for this ratio to remain high enough for the descent gradient to be steep enough in flight idle. Failing that, it is necessary to use means for reducing the lift of the airplane or increasing its drag, which consumes fuel. Similarly, in ground idle, an excessively high idle thrust leads to faster wear on the brakes.

### SUMMARY OF THE INVENTION

One subject of the invention is that of reducing the idle thrust of an aircraft propulsion system.

For this purpose, the invention has the subject, according to a first aspect, of a propulsion system of the aforementioned type, in which the control system is configured to limit a current electrical power generated by the rotary machine, at least when the engine spool is in the acceleration phase, to a maximum authorized power which is a function of the current engine speed before acceleration, and in which the propulsion system comprises a device for determining the current electrical power generated by the rotary machine, the control system being configured to establish the engine speed above an idle speed which is a function of the current electrical power.

According to particular embodiments of the invention, the propulsion system also has one or more of the following features, taken in isolation or in any possible technical combination(s):
the propulsion system comprises a system for deducing a future requirement of the aircraft for electrical power generated by the rotary machine, the control system being configured to accelerate the engine spool when said future requirement is greater than the maximum authorized power;
when the engine speed is established at the idle speed, the current electrical power constitutes the maximum authorized power;
the idle speed is greater than or equal to an acceleration limit speed for which the engine spool, accelerating to the stall limit from said acceleration limit speed while the rotary machine is generating the current electrical power, reaches without stalling, in an allotted time less than or equal to 10 seconds, a target speed at which the gas turbine engine produces a substantial percentage of a full-throttle thrust;
the idle speed is greater than or equal to an overheat limit speed for which, when the engine spool is rotating at said overheat limit speed while the rotary machine is generating the current electrical power, the temperature of the gas at the outlet of the gas turbine engine is equal to a predetermined maximum temperature;
the idle speed is equal to the maximum of the acceleration limit speed and of the overheat limit speed;
the maximum authorized power is less than or equal to an acceleration limit power for which the engine spool, accelerating to the stall limit from the current engine speed while the rotary machine is generating said acceleration limit power, reaches without stalling, in an allotted time less than or equal to 10 seconds, a target speed at which the gas turbine engine produces a substantial percentage of a full-throttle thrust;
the maximum authorized power is less than or equal to an overheat limit power for which, when the engine spool is rotating at the current speed while the rotary machine is generating said overheat limit power, the temperature of the gas at the outlet of the gas turbine engine is equal to a predetermined maximum temperature;
the maximum authorized power is equal to the minimum of the acceleration limit power and the overheat limit power;
the control system is configured to limit the electrical power generated by the rotary machine when the engine spool is not in the acceleration phase;
the propulsion system comprises an electric motor coupled to the transmission shaft; and
the gas turbine engine is a turbojet engine.

Another subject of the invention is, according to a second aspect, a method for controlling an aircraft propulsion system, the propulsion system comprising a gas turbine engine with a combustion chamber and an engine spool, the engine spool including a turbine downstream of the combustion chamber, a compressor upstream of the combustion chamber and a transmission shaft for driving the compressor via the turbine, the propulsion system also comprising a rotary machine coupled to the transmission shaft for generating electrical power by taking off mechanical power from the transmission shaft, the control method comprising the following successive steps:
determining a current electrical power generated by the rotary machine,
defining an idle speed which is a function of the current electrical power, and establishing the engine speed above the idle speed,
determining a current engine speed of the engine spool,
defining a maximum authorized power which is a function of the current engine speed, and
accelerating the engine spool, the current electrical power generated by the rotary machine being limited to the maximum authorized power.

According to particular embodiments of the invention, the control method also has one or more of the following features, taken in isolation or in any possible technical combination(s):
the control method also comprises the following steps:
   deducing a future requirement of the aircraft for electrical power
   generated by the rotary machine,
   modifying the idle speed so that it satisfies said future requirement,
   comparing the new idle speed with the current engine speed, and
   if the new idle speed is greater than the current engine speed, accelerating the engine spool;
during the step of establishing the engine speed, the engine speed is established at the idle speed, the current electrical power then constituting the maximum authorized power;
the control method also comprises a step of accelerating the engine spool from said idle speed while the rotary machine is generating the current electrical power, the engine spool reaching without stalling, in an allotted time less than or equal to 10 seconds, a target speed at which the gas turbine engine produces a substantial percentage of a full-throttle thrust;
the definition of the idle speed comprises the following sub-steps:
   computing an acceleration limit speed for which the engine spool, accelerating to the stall limit from said acceleration limit speed while the rotary machine is generating the current electrical power, reaches without stalling, in an allotted time less than or equal to 10 seconds, a target speed at which the gas turbine engine produces a substantial percentage of a full-throttle thrust, and
   assigning to the idle speed a value greater than or equal to that of the acceleration limit speed;
the defining of the idle speed comprises the following sub-steps:
   computing an overheat limit speed for which, when the engine spool is rotating at said overheat limit speed while the rotary machine is generating the current electrical power, the temperature of the gas at the outlet of the gas turbine engine is equal to a predetermined maximum temperature, and
   assigning to the idle speed a value greater than or equal to that of the overheat limit speed;
the defining of the idle speed comprises the assigning to the idle speed of a value equal to the maximum of the acceleration limit speed and of the overheat limit speed;
the control method also comprises a step of accelerating the engine spool from the current engine speed while the rotary machine is generating the maximum authorized power, the engine spool reaching without stalling, in an allotted time less than or equal to 10 seconds, a target speed at which the gas turbine engine produces a substantial percentage of a full-throttle thrust;
the definition of the maximum authorized power comprises the following sub-steps:
   computing an acceleration limit power for which the engine spool, accelerating to the stall limit from the current engine speed while the rotary machine is generating said acceleration limit power, reaches without stalling, in an allotted time less than or equal to 10 seconds, a target speed at which the gas turbine engine produces a substantial percentage of a full-throttle thrust, and
   assigning to the maximum power a value less than or equal to that of the acceleration limit power;
the defining of the maximum authorized power comprises the following sub-steps:
   computing an overheat limit power for which, when the engine spool is rotating at the current speed while the rotary machine is generating said overheat limit power, the temperature of the gas at the outlet of the gas turbine engine is equal to a predetermined maximum temperature, and
   assigning to the maximum power a value less than or equal to that of the overheat limit power;
the defining of the maximum authorized power comprises the assigning to the maximum power of a value equal to the minimum of the values of the acceleration limit power and of the overheat limit power;
the method also comprises, before the step of accelerating the engine spool, a step of limiting the electrical power generated by the rotary machine while the engine spool is rotating at the current engine speed; and
the accelerating step comprises the injecting of mechanical power onto the transmission shaft by an electric motor coupled to the transmission shaft.

### BRIEF DESCRIPTION OF THE FIGURES

Other features and advantages of the invention will become apparent on reading the following description, given solely by way of example and with reference to the appended drawings, wherein:

FIG. 1 is a top view of an aircraft comprising two propulsion systems according to an exemplary embodiment of the invention,

FIG. 2 is a block diagram of one of the propulsion systems of the aircraft of FIG. 1,

FIG. 3 is a simplified longitudinal section view of a gas turbine engine of the propulsion system of FIG. 2,

FIG. 4 is a diagram illustrating a method implemented by a control system of the propulsion system of FIG. 2,

FIG. 5 is a graphic giving the relationship between an engine idle speed and a current electrical power of the propulsion system of FIG. 2,

FIG. 6 is a first graph showing the characteristic curves of a compressor of the gas turbine engine of FIG. 3 in different scenarios,

FIG. 7 is a first graph giving the variation over time of the engine speed of the gas turbine engine of FIG. 3 in different scenarios,

FIG. 8 is a first graph giving the relationship between the engine speed and the temperature at the outlet of the gas turbine engine of FIG. 3 in different scenarios,

FIG. 9 is a graph giving the relationship between a current engine speed and a maximum authorized power of the propulsion system of FIG. 2,

FIG. 10 is a second graph giving the variation over time of the engine speed of the gas turbine engine of FIG. 3 in different scenarios,

FIG. 11 is a second graph showing the characteristic curves of a compressor of the gas turbine engine of FIG. 3 in different scenarios, and

FIG. 12 is a second graph giving the relationship between the engine speed and the temperature at the outlet of the gas turbine engine of FIG. 3 in different scenarios.

### DETAILED DESCRIPTION OF AN EMBODIMENT

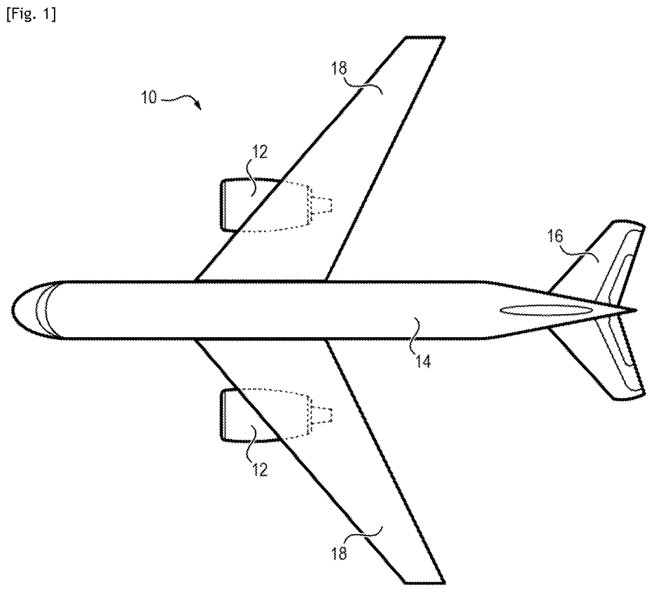

The aircraft 10 shown on FIG. 1 comprises propulsion systems 12 to propel it.

In the example shown, the aircraft 10 is an airplane. This comprises, conventionally, a fuselage 14, a tail 16 and two wings 18. Here the propulsion systems 12 are two in number and are each housed under a respective wing 18. In a variant (not shown), the propulsion systems 12 are disposed along the fuselage 14, for example near the tail 16. In another variant (also not shown), the aircraft 10 comprises a single propulsion system 12 or at least three propulsion systems 12.

The aircraft 10 also comprises an electrical system (not shown).

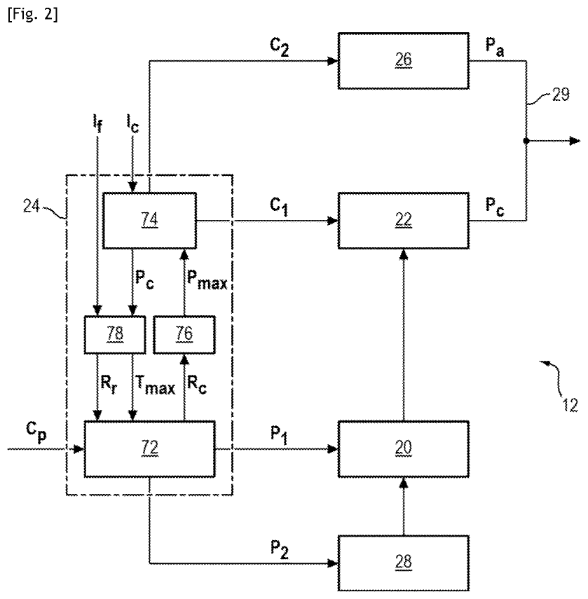

One of the propulsion systems 12 is shown on FIG. 2.

This propulsion system 12 comprises a gas turbine engine 20, a rotary machine 22 for generating electricity, and a control system 24. In the example shown, the propulsion system 12 also comprises at least one auxiliary source of electrical power 26, for example a battery or a fuel cell, and an electric motor 28.

The propulsion system 12 also comprises a transmission member 29 to transmit to the electrical system of the aircraft 10 the electricity produced by the rotary machine 22 or provided by the or each auxiliary power source 26.

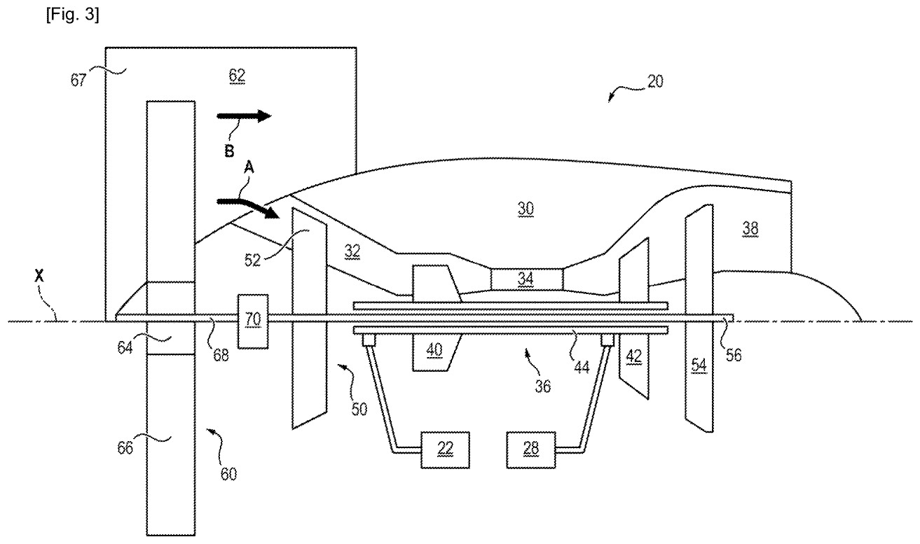

With reference to FIG. 3, the gas turbine engine 20 comprises, conventionally, an engine casing 30, an inner air path 32 for the circulation of a stream of air through the engine casing 30, a combustion chamber 34 housed in the air path 32, an engine spool 36 and a gas exhaust nozzle 38.

In the remainder of the text, the terms “upstream” and “downstream” are to be understood with reference to a direction of flow of a stream of air through the air path 32.

The engine spool 36 comprises a compressor 40, a turbine 42 and a transmission shaft 44 coupling the turbine 42 to the compressor 40 to drive the compressor 40 via the turbine 42. The compressor 40 is disposed upstream of the combustion chamber 34 and supplies the combustion chamber 34 with compressed air. The turbine 42 is disposed downstream of the combustion chamber 34 and receives the exhaust gases leaving the combustion chamber 34.

The transmission shaft 44 has as axis of rotation a longitudinal axis X. The longitudinal axis X is typically an axis of angular symmetry of the gas turbine engine 20, i.e. there is at least one angle for which the gas turbine engine 20 is rotationally invariant about the longitudinal axis X.

The transmission shaft 44 is rotationally guided with respect to the engine casing 30 by way of bearings (not shown).

The engine spool 36 is able to rotate about the axis X at a rotational velocity known as the engine speed. This engine speed is in particular a function of the temperature of the gas at the outlet of the combustion chamber 34.

In the example shown, the gas turbine engine 20 is a multi-spool gas turbine engine, in particular twin-spool, comprising a low-pressure spool 50 in addition to the engine spool 36. The engine spool 36 then constitutes a high-pressure spool, the compressor 40 being a high-pressure compressor, the turbine 42 being a high-pressure turbine and the transmission shaft 44 being a high-pressure shaft.

The low-pressure spool 50 comprises a low-pressure compressor 52, a low-pressure turbine 54 and a low-pressure shaft 56 coupling the low-pressure turbine 54 to the low-pressure compressor 52 to drive the low-pressure compressor 52 via the low-pressure turbine 54.

The low-pressure compressor 52 is disposed upstream of the high-pressure compressor 40 and supplies the latter with compressed air. The low-pressure turbine 54 is disposed downstream of the high-pressure turbine 42 and receives the exhaust gas leaving the latter.

The low-pressure shaft 56 is rotationally guided with respect to the engine casing 30 by way of bearings (not shown).

The low-pressure shaft 56 is coaxial with the high-pressure shaft 44. It therefore also has as axis of rotation the longitudinal axis X. In particular, the low-pressure shaft 56 extends inside the high-pressure shaft 44.

In the example shown, the gas turbine engine 20 is also a bypass gas turbine engine comprising a fan 60 to drive the stream of air into an outer air flow path 62 surrounding the engine casing 30. One can thus discern a primary air stream A (hot), consisting of the portion of the air stream driven in the inner air flow path 32, and a secondary air stream B (cold), consisting of the portion of the air stream driven in the outer air flow path 62.

The gas turbine engine 20 is advantageously of the kind with a high bypass ratio, the bypass ratio being defined as the ratio of the flow rate of the secondary stream B (cold) to the flow rate of the primary stream A (hot).

The fan 60 comprises a fan disc 64 equipped with fan blades 66 at its periphery which, when set in rotation, drive the air stream through the outer air flow path 62.

Here, the fan 60 is disposed upstream of the inner air flow path 32 and also drives the air stream through the latter.

The outer air flow path 62 is here defined between the engine casing 30 and a fan casing 67 surrounding the fan 60.

The fan 60 is rotationally driven by the low-pressure turbine 54, by way of the low-pressure shaft 56. In the example shown, this driving is indirect, to allow the fan 60 to rotate at a lower speed than that of the low-pressure turbine 54. For this purpose, the gas turbine engine 20 here comprises a fan shaft 68 on which the fan disc 64 is mounted fixedly and a reducer 70 coupling the fan shaft 68 to the low-pressure shaft 56. The fan 60 is thus rotationally driven by the low-pressure shaft 56 by way of the reducer 70 and the fan shaft 68.

The fan shaft 68 is rotationally guided with respect to the engine casing 30 by way of bearings (not shown).

The gas turbine engine 20 is typically a turbojet engine.

As can be seen on FIG. 3, the rotary machine 22 is coupled to the high-pressure shaft 44 so as to be rotationally driven by way of said high-pressure shaft 44. It is suitable for generating an electrical power by taking off mechanical power from said high-pressure shaft 44.

Advantageously, the rotary machine 22 is suitable for being uncoupled from the high-pressure shaft 44.

Still with reference to FIG. 3, the electric motor 28 is coupled to the high-pressure shaft 44 so as to drive said high-pressure shaft 44 in rotation about the axis X. This motor 28 is suitable for converting an electrical power into mechanical power and for injecting this latter onto the high-pressure shaft 44.

Advantageously, the electric motor 28 is suitable for being uncoupled from the high-pressure shaft 44.

Returning to FIG. 2, the control system 24 comprises an engine control module 72 and a module 74 for commanding the electrical sources. It also comprises a system 76 for governing the power take-offs and a system 78 for managing the engine idle.

The engine control module 72 is configured to control the engine speed of the engine spool 36. For this purpose, the engine control module 72 is configured to determine a current speed R_{c} of the engine spool 36 and to communicate at least one command parameter P₁, P₂ to the gas turbine engine 20 and/or to the electric motor 28 to establish the engine speed at a target speed.

The current speed R_{c} is for example determined by the engine control module 72 on the basis of the command parameters P₁, P₂ communicated by the engine control module 72 to the gas turbine engine 20 and/or to the electric motor 28 (open-loop operation). In a variant, the current speed R_{c} is communicated to the engine control module 72 by a sensor (not shown) of the gas turbine engine 20 (closed-loop operation).

The engine control module 72 is in particular configured to communicate to the gas turbine engine 20 at least one command parameter P₁ suitable for stabilizing the engine speed above an idle speed Rᵣ supplied by the managing system 78. It is also configured to receive a thrust setpoint Cₚ of the aircraft 10 and to communicate to the gas turbine engine 20 and/or to the electric motor 28 at least one command parameter P₁, P₂ suitable for accelerating the engine spool 36 to an acceleration rate which is a function of the thrust setpoint Cₚ and of the current engine speed R_{c}. The acceleration rate is capped at a maximum acceleration rate Tₘₐₓ supplied by the managing system 78.

The thrust setpoint Cₚ is less than or equal to a full-throttle thrust setpoint. This full-throttle thrust setpoint is, in a known manner, intended to set the fan 60 in motion at a predetermined speed in such a way as to obtain a so-called “full-throttle” thrust, which is a function of the flight conditions. To this predetermined speed of the fan 60 there corresponds a speed that will be referred to as the “full-throttle” speed of the engine spool 36, which is thus itself a function of the flight conditions. This full-throttle speed is written R_{gaz} on the Figures. When the thrust setpoint Cₚ is equal to the full-throttle thrust setpoint, this is therefore interpreted by the engine control module 72 as a setpoint for accelerating the engine spool 36 to said full-throttle speed.

A first command parameter P₁, communicated to the gas turbine engine 20 is, for example, a setpoint for metering the fuel to be injected into the combustion chamber 34. A second command parameter P₂, communicated to the electric motor 28 is, for example, a torque setpoint.

The engine control module 72 is also configured to communicate the current engine speed R_{c} to the governing system 76.

The command module 74 is configured to control the electrical power supplied to the electrical system of the aircraft 10 by the rotary machine 22 and the or each auxiliary source 26. For this purpose, the command module 74 is configured to determine a current electrical power P_{c} generated by the rotary machine 22 and an auxiliary electrical power Pₐ supplied by the auxiliary source or sources 26 and to communicate to the rotary machine 22 and/or to the or each auxiliary source 26 at least one setpoint C₁, C₂ suitable for adjusting the current electrical power P_{c} and the auxiliary electrical power Pₐ.

The current and auxiliary electrical powers P_{c}, Pₐ are for example determined by the command module 74 on the basis of the setpoints C₁, C₂ communicated by the command module 74 to the rotary machine 22 and to the or each auxiliary source 26 (open-loop operation). In a variant, the current and auxiliary electrical powers P_{c}, Pₐ are communicated to the command module 74 by sensors (not shown) at the rotary machine 22, at the or each auxiliary source 26 and/or at the transmission member 29 (closed-loop operation).

A first setpoint C₁, communicated to the rotary machine 22, is, for example, a setpoint of injection of an excitation current into a winding of the rotary machine 22. A second setpoint C₂, communicated to an auxiliary source 26 is, for example, a setpoint for closing a switch connecting the auxiliary source 26 to the distribution member 29.

Typically, the command module 74 is configured to receive an item of information I_{c} about the current electrical power requirements of the aircraft 10 and to communicate to the rotary machine 22 and/or to the or each auxiliary source 26 at least one setpoint C₁, C₂ adapted so that the sum of the current and auxiliary electrical powers P_{c}, Pₐ satisfies the requirements reflected by the item of information I_{c}.

In particular, the command module 74 is configured to limit the current electrical power P_{c}, at least during certain phases, to a maximum authorized electrical power Pₘₐₓ supplied by the governing system 76, and to command the auxiliary source or sources 26 so that this latter or these latters tops up or top up the electrical power requirements of the aircraft 10. In other words, the command module 74 is configured to command the rotary machine 22 such that the current electrical power P_{c} generated by this latter is equal to the power Pₘₐₓ or, if these are lower, to the current requirements reflected by the item of information I_{c}, and to command the auxiliary source or sources 26 such that this latter or these latters supplies or supply, when the current requirements reflected by the item of information I_{c} are greater than the power Pₘₐₓ, an auxiliary electrical power Pₐ equal to the difference between said current requirements and the power Pₘₐₓ.

The command module 74 is configured to apply this limitation of the current electrical power P_{c} particularly when the engine spool 36 is in the acceleration phase. Preferably, the command module 74 is configured to apply this limitation of the current electrical power P_{c} at any time, including when the engine spool 36 is not in the acceleration phase.

Advantageously, the command module 74 is also configured to communicate the current electrical power P_{c} to the managing system 78.

The governing system 76 is configured to receive from the engine control module 72 an item of information representative of the current engine speed R_{c} and to deduce from this latter the maximum authorized power Pₘₐₓ. The governing system 76 is also configured to communicate this maximum authorized power Pₘₐₓ to the command module 74.

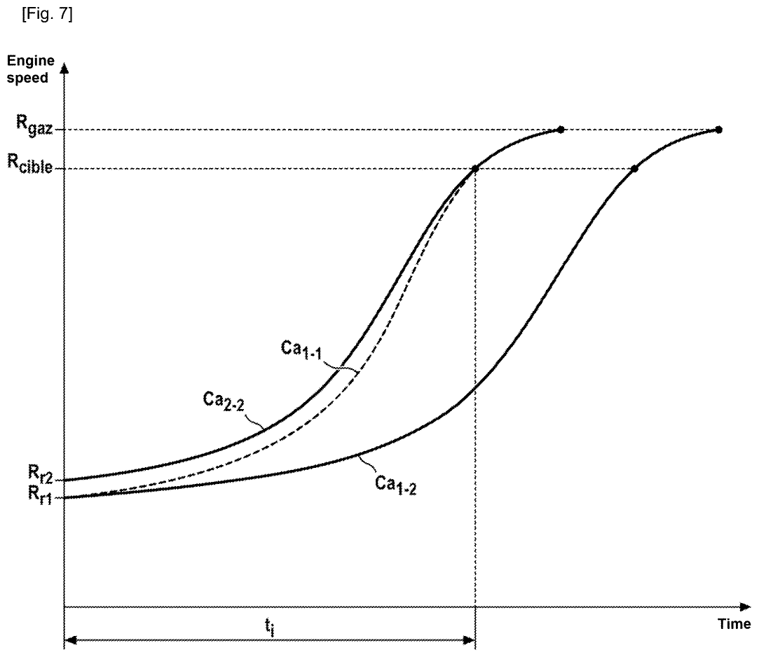

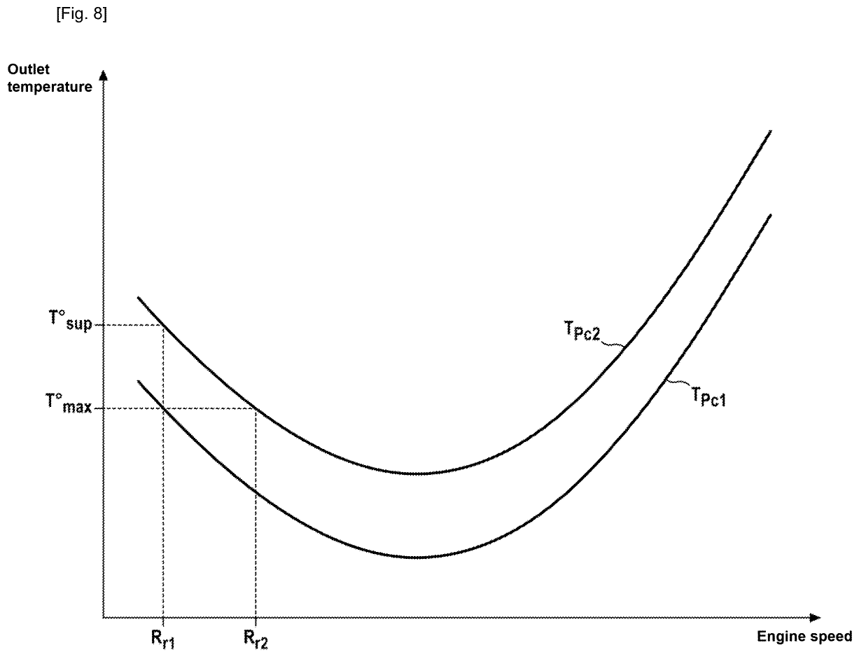

In particular, the governing system 76 is configured to determine the maximum authorized power Pₘₐₓ such that the two following constraints are respected:
the engine spool 36, accelerating from the current engine speed R_{c} while the rotary machine 22 is generating the maximum authorized power Pₘₐₓ, reaches without stalling in an allotted time tᵢ (FIG. 7) less than or equal to 10 seconds, for example between 7.5 and 8.5 seconds, a target speed R_{cible} (FIG. 7) at which the gas turbine engine 20 produces a substantial percentage, typically between 89 and 91%, of the full-throttle thrust, and
the temperature at the outlet of the gas turbine engine 20, for example at the output of the low-pressure turbine 54, stays below a predetermined maximum temperature T°ₘₐₓ (FIG. 8) when the engine spool 36 is rotating at the current speed R_{c} while the rotary machine 22 generates the maximum authorized power Pₘₐₓ.

For this purpose, the governing system 76 is configured to determine the maximum authorized power Pₘₐₓ such that it is less than or equal to:
an acceleration limit power for which the engine spool 36, accelerating to the stall limit from the current engine speed R_{c} while the rotary machine 22 is generating said acceleration limit power, reaches without stalling said target speed R_{cible} in said allotted time tᵢ, and at
an overheat limit power for which, when the engine spool 36 is rotating at the current speed R_{c} while the rotary machine 22 is generating said overheat limit power, the temperature of the gas at the outlet of the gas turbine engine 20 is equal to said predetermined maximum temperature T°ₘₐₓ.

In particular, the governing system 76 is configured to determine the maximum authorized power Pₘₐₓ so that it is equal to the minimum of the acceleration limit power and of the overheat limit power.

For this purpose, the governing system 76 is for example configured to compute, based on parameters of the gas turbine engine 20 and on the current engine speed R_{c}, the acceleration limit power and the overheat limit power, and to then determine the maximum authorized power Pₘₐₓ as a function of said limit powers. In a variant, the maximum authorized power Pₘₐₓ which observes these constraints and is a function of the flight conditions has been determined beforehand for each possible engine speed, and the governing system 76 is parameterized with a function associating with each possible engine speed, as a function of the flight conditions, the corresponding maximum authorized power Pₘₐₓ.

The managing system 78 is configured to receive from the command module 74 an item of information representative of the current electrical power P_{c} and to deduce from this latter the idle speed Rᵣ and the maximum acceleration rate Tₘₐₓ. The managing system 78 is also configured to communicate said idle speed Rᵣ and maximum acceleration rate Tₘₐₓ to the engine control module 72.

In particular, the managing system 78 is configured to define the maximum acceleration rate Tₘₐₓ above a limit acceleration rate beyond which the compressor 40 stalls when the current electrical power P_{c} is generated.

The managing system 78 is moreover configured to define the idle speed Rᵣ so that the two following constraints are observed:
the engine spool 36, accelerating from the idle speed Rᵣ to the maximum acceleration rate Tₘₐₓ while the rotary machine 22 is generating the current electrical power P_{c}, reaches without stalling the target speed R_{cible} in the allotted time tᵢ, and
the temperature at the outlet of the gas turbine engine 20, for example at the outlet of the low-pressure turbine 54, remains below the predetermined maximum temperature T°ₘₐₓ when the engine spool 36 is rotating at the idle speed Rᵣ while the rotary machine 22 is generating the current electrical power P_{c}.

For this purpose, the managing system 78 is configured to determine the idle speed Rᵣ such that it is greater than or equal to:
an acceleration limit speed for which the engine spool 36, accelerating to the stall limit from said acceleration limit speed while the rotary machine 22 is generating the current electrical power P_{c}, reaches without stalling said target speed R_{cible} in said allotted time tᵢ, and to
an overheat limit speed for which, when the engine spool 36 is rotating at said overheat limit speed while the rotary machine 22 is generating the current electrical power P_{c}, the temperature of the gas at the outlet of the gas turbine engine 20 is equal to the predetermined maximum temperature T°ₘₐₓ.

In particular, the managing system 78 is configured to determine the idle speed Rᵣ such that it is equal to the maximum of the acceleration limit speed and of the overheat limit speed.

For this purpose, the managing system 78 is for example configured to compute, based on parameters of the gas turbine engine 20 and on the current electrical power P_{c}, the acceleration limit speed and the overheat limit speed, and to then determine the idle speed Rᵣ as a function of said limit speeds. In a variant, an idle speed Rᵣ which observes these constraints and is a function of the flight conditions has been determined beforehand for each possible generated electrical power, and the managing system 78 is parameterized with a function associating with each possible generated electrical power, as a function of the flight conditions, the corresponding idle speed Rᵣ.

It will easily be understood that, when the engine speed is established at the idle speed Rᵣ, the current electrical power P_{c} constitutes the maximum authorized power Pₘₐₓ.

The managing system 78 is also configured to receive from the aircraft 10 an item of information I_{f} representative of a future electrical power requirement of the aircraft 10 and to deduce from this item of information I_{f} the future electrical power requirement of the aircraft 10. The managing system 78 is also configured to modify the idle speed Rᵣ for it to satisfy this future requirement and to communicate the idle speed Rᵣ thus modified to the engine control module 72.

In particular, the managing system 78 is configured to only modify the idle speed Rᵣ on the basis of the item of information I_{f} when the future requirement is greater than the current electrical power P_{c} (it being understood that the managing system 78 is moreover configured to modify the idle speed Rᵣ, upward or downward, as a function of the current electrical power P_{c}). The managing system 78 is configured so that, in such a case, the idle speed Rᵣ is increased so that the two following constraints are observed:
the engine spool 36, accelerating from the idle speed Rᵣ to the maximum acceleration rate Tₘₐₓ while the rotary machine 22 generates an electrical power equal to the future requirement, reaches without stalling the target speed R_{cible} in the allotted time tᵢ, and
the temperature at the outlet of the gas turbine engine 20, for example at the outlet of the low-pressure turbine 54, stays below the predetermined maximum temperature T°ₘₐₓ when the engine spool 36 is rotating at the idle speed Rᵣ while the rotary machine 22 is generating an electrical power equal to the future requirement.

For this purpose, the managing system 78 is configured to modify the idle speed Rᵣ so that it is greater than or equal to:
a future acceleration limit speed for which the engine spool 36, accelerating to the stall limit from said future acceleration limit speed while the rotary machine 22 is generating an electrical power equal to the future requirement, reaches without stalling said target R_{cible} in said allotted time tᵢ, and to
a future overheat limit speed for which, when the engine spool 36 is rotating at said overheat limit speed while the rotary machine 22 is generating an electrical power equal to the future requirement, the temperature of the gas at the outlet of the gas turbine engine 20 is equal to the predetermined maximum temperature T°ₘₐₓ.

In particular, the managing system 78 is configured to modify the idle speed Rᵣ such that it is equal to the maximum of the acceleration limit speed and of the overheat limit speed.

For this purpose, the managing system 78 is for example configured to compute, based on parameters of the gas turbine engine 20 and on the future requirement, the future acceleration limit speed and the future overheat limit speed, and to then modify the idle speed Rᵣ as a function of said future limit speeds. In a variant, an idle speed Rᵣ observing these constraints and which is a function of the flight conditions has been determined beforehand for each possible generated electrical power, and the managing system 78 is parameterized with a function associating with each possible generated electrical power the corresponding idle speed Rᵣ as a function of the flight conditions.

It will easily be understood that, when the future requirement is greater than the maximum authorized power Pₘₐₓ, the idle speed Rᵣ thus modified is raised to a value greater than that of the current speed R_{c}. This mechanically drives an acceleration of the engine spool 36, since the engine control module 72 is configured to establish the engine speed above the idle speed Rᵣ.

The control system 24, particularly including the engine control module 72, the command module 74, the governing system 76 and the managing system 78, is typically embodied in the form of a computer program stored in a memory of a processing system (not shown) of the propulsion system 12 and able to be executed by a processor (not shown) associated with said memory. In a variant, the control system 24 is at least partially embodied in the form of a programmable logic component, or else in the form of a dedicated integrated circuit, included in the propulsion system 12.

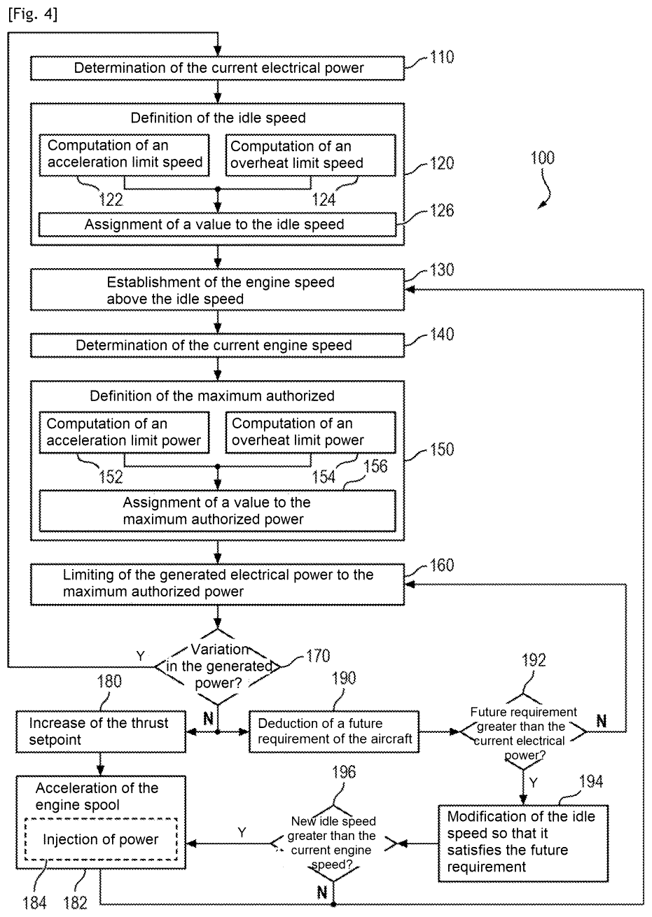

A control method 100 implemented by the propulsion system will now be described, with reference to FIG. 4.

This method 100 comprises a first step 110 of determining the current electrical power P_{c}. During this step 110, the command module 74 determines the current electrical power P_{c} generated by the rotary machine 22, for example on the basis of the setpoints C₁, C₂ it communicates to the rotary machine 22 or on the basis of an item of information communicated to the command module 74 by a sensor (not shown) at the rotary machine 22 or at the transmission member 29 (closed-loop operation).

This step 110 is followed by a step 120 of defining the idle speed Rᵣ. During this step, the managing system 78 defines the idle speed Rᵣ as a function of the current electrical power P_{c}.

In the example shown, the step 120 comprises a first sub-step 122 of computing the acceleration limit speed, a second sub-step 124 of computing the overheat limit speed, and a third sub-step 126 of assigning a value to the idle speed Rᵣ. During the first sub-step 122, the managing system 78 computes the acceleration limit speed as a function of the current electrical power P_{c}. During the second sub-step 124, the managing system 78 computes the overheat limit speed as a function of the current electrical power P_{c}. Finally, during the third sub-step 126, the managing system 78 assigns to the idle speed Rᵣ a value greater than or equal to those of the acceleration limit speed and of the overheat limit speed. Typically, the managing system 78 assigns to the idle speed Rᵣ, during this sub-step 126, a value equal to the maximum of the acceleration limit speed and of the overheat limit speed.

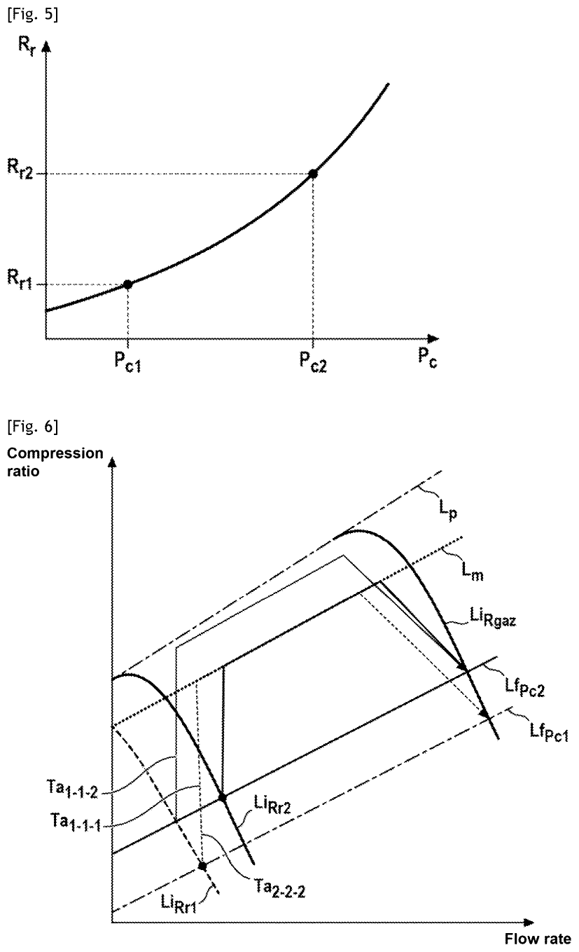

In a variant (not shown), the step 120 comprises the only sub-step 126 of assigning a value to the idle speed Rᵣ. In this variant, the managing system 78 assigns to the idle speed Rᵣ, during this sub-step 126, a value determined by a function parameterized in the managing system 78, said function associating with the current electrical power P_{c}, for a given flight condition, the corresponding idle speed Rᵣ. An example of such a function is given on FIG. 5.

As can be seen on FIG. 5, the engine idle speed Rᵣ tends to increase with the current electrical power P_{c}: the first engine idle speed Rᵣ₁ associated with a first current power P_{c1} is less than the second engine idle speed Rᵣ₂ associated with a second current power P_{c2} greater than the first current power P_{c1}. This is easily explained, as detailed below with reference to FIGS. 6 to 8.

FIG. 6 is a flow rate/compression ratio graph showing the characteristic curves of the high-pressure compressor 40 of the gas turbine engine 20 in different scenarios. The following are shown therein:
the surge line Lp of the high-pressure compressor 40; as is well-known to those skilled in the art, this is a line beyond which the high-pressure compressor 40 stalls;
the margin line Lm of the high-pressure compressor 40; as is well-known to those skilled in the art, this is a line beyond which the risk of the high-pressure compressor 40 stalling do not make it possible to comply with the aeronautical safety requirements;
the operating lines Lf_{Pc1} and Lf_{Pc2} of the high-pressure compressor 40 when the electrical power generated by the rotary machine 22 is equal, respectively, to the first current power P_{c1} and to the second current power P_{c2}; as is well-known to those skilled in the art, these operating lines Lf_{Pc1} and Lf_{Pc2} define the flow rate—compression ratio pairs for which the high-pressure compressor 40 has a stable operation when the electrical power generated by the rotary machine 22 is equal, respectively, to the first current power P_{c1} and to the second current power P_{c2};
the isospeed lines Li_{Rr1}, Li_{Rr2} and Li_{Rgaz} of the high-pressure compressor 40 at the first engine idle speed Rᵣ₁, at the second engine idle speed Rᵣ₂ and at the full-throttle speed R_{gaz}; as is well-known to those skilled in the art, these isospeed lines Li_{Rr1}, Li_{Rr2} and Li_{Rgaz} define flow rate-compression ratio pairs reachable by the of the high-pressure compressor 40 when the engine spool 36 is rotating, respectively, at the first engine idle speed Rᵣ₁, at the second engine idle speed Rᵣ₂ and at the full-throttle speed R_{gaz}; and
the acceleration transient curves Ta₁₋₁₋₁, Ta₁₋₁₋₂ and Ta₂₋₂₋₂ representing the variation in the compression ratio as a function of the flow rate when the engine spool 36 is respectively accelerated:
   from the first engine idle speed Rᵣ₁, at a first acceleration rate T₁ while the electrical power generated by the rotary machine 22 is equal to the first current power P_{c1},
   from the first engine idle speed Rᵣ₁, at the first acceleration rate T₁ while the electrical power generated by the rotary machine 22 is equal to the second current power P_{c2}, and
   from the second engine idle speed Rᵣ₂, at a second acceleration rate T₂ less than the first acceleration rate T₁ while the electrical power generated by the rotary machine 22 is equal to the second current power P_{c2}.

FIG. 7, meanwhile, is a graph giving the variation over time of the engine speed of the engine spool 36 in different scenarios. The following are shown therein:

a first acceleration curve Ca₁₋₁ of the engine spool 36 when this latter is accelerated from the first engine idle speed Rᵣ₁ at the first acceleration rate T₁,
a second acceleration curve Ca₁₋₂ of the engine spool 36 when this latter is accelerated from the first engine idle speed Rᵣ₁ at the second acceleration rate T₂, and
a third acceleration curve Ca₂₋₂ of the engine spool 36 when this latter is accelerated from the second engine idle speed Rᵣ₂ at the second acceleration rate T₂.

As can be seen on FIG. 6, the acceleration transient curve Ta₁₋₁₋₁ partly runs along the margin line Lm. This means that the high-pressure compressor 40 is at the stall limit during the phase of acceleration at the first acceleration rate T₁. The first acceleration rate T₁ therefore constitutes the maximum acceleration rate Tₘₐₓ for the first current power P_{c1}. As illustrated by the acceleration curve Ca₁₋₁ on FIG. 7, this acceleration rate T₁ does indeed make it possible to accelerate the engine spool 36 from the first engine idle speed Rᵣ₁ so as to reach the target speed R_{cible} in the allotted time tᵢ.

If one wished to accelerate the engine spool 36 at this same first acceleration rate T₁ from the same first engine speed Rᵣ₁ when the electrical power generated by the rotary machine 22 is equal to the second current power P_{c2}, the compression ratio of the high-pressure compressor 40 would follow the acceleration transient curve Ta₁₋₁₋₂. However, as can be seen on FIG. 6, this acceleration transient curve Ta₁₋₁₋₂ crosses the margin line Lm. Accelerating the engine spool 36 at the first acceleration rate T₁ when the electrical power generated by the rotary machine 22 is equal to the second current power P_{c2} therefore involves an excessive risk of stalling of the high-pressure compressor 40, so this first acceleration rate T₁ is unacceptable. To accelerate the engine spool 36 when the electrical power generated by the rotary machine 22 is equal to the second current power P_{c2}, it is therefore advisable to use a lower acceleration rate for which the acceleration transient curve at least partly runs along the margin line Lm without ever crossing it: this lower acceleration rate consists of the second acceleration rate T₂, as illustrated by the acceleration transient curve Ta₂₋₂₋₂ on FIG. 6.

However, as illustrated by the acceleration curve Ca₁₋₂ on FIG. 7, accelerating the engine spool 36 at the second acceleration rate T₂ from the first engine idle speed Rᵣ₁ does not make it possible to reach the target speed R_{cible} in the allotted time tᵢ. To achieve this objective, it is therefore necessary to raise the engine idle speed Rᵣ to the second engine idle speed Rᵣ₂, as illustrated by the curve Ca₂₋₂ of FIG. 7.

The second engine idle speed Rᵣ₂ must therefore be greater than the first engine idle speed Rᵣ₁ to allow the engine spool 36 to reach the target speed R_{cible} in the allotted time tᵢ, without stalling, since the electrical power generated by the rotary machine 22 is equal to the second current power P_{c2}.

The second engine idle speed Rᵣ₂ must also be greater than the first engine idle speed Rᵣ₁ to avoid the temperature of the exhaust gas at the outlet of the gas turbine engine 20 exceeding the maximum temperature T°ₘₐₓ, as will be understood on reading FIG. 8.

FIG. 8 is specifically a graph giving the relationship between the engine speed of the engine spool 36 and the temperature at the outlet of the gas turbine engine 20 in different scenarios. The following are shown therein:
a first temperature curve T_{Pc1} of the outlet of the gas turbine engine 20 when the electrical power generated by the rotary machine 22 is equal to the first current power P_{c1}, and
a second temperature curve T_{Pc2} of the outlet of the gas turbine engine 20 when the electrical power generated by the rotary machine 22 is equal to the second current power P_{c2}.

As can be seen on FIG. 8, the first and second temperature curves T_{Pc1}, T_{Pc2} each have a U-shaped profile, the range of variation of the idle speed Rᵣ lying in the region of the graph in which these curves are decreasing. In addition, the first idle speed Rᵣ₁ is such that when the engine spool 36 is rotating at said idle speed Rᵣ₁ while the electrical power generated by the rotary machine 22 is equal to the first current power P_{c1}, the temperature at the outlet of the gas turbine engine 20 is equal to the maximum temperature T°ₘₐₓ. Finally, the second temperature curve T_{Pc2} is logically located above the first temperature curve T_{Pc1}, insofar as the supply of the rotary machine 22 with mechanical energy requires, for equal engine speeds, the burning of more combustive substances in the combustion chamber 34. This entails that if the engine spool 36 could rotate at the first idle speed Rᵣ₁ when the electrical power generated by the rotary machine 22 is equal to the second current power P_{c2}, the temperature at the outlet of the gas turbine engine 20 would then be at a value T°ₛᵤₚ greater than the maximum temperature T°ₘₐₓ. To avoid this, a higher second engine idle speed Rᵣ₂ is chosen, this second engine idle speed Rᵣ₂ consisting of the lowest engine speed for which the temperature at the outlet of the gas turbine engine 20 is less than or equal to the maximum temperature Tₘₐₓ when the electrical power generated by the rotary machine 22 is equal to the second current power P_{c2}.

Returning to FIG. 4, the step 120 is followed by a step 130 of establishing the engine speed above the idle speed Rᵣ. During this step 130, the engine control module 72 sends at least one command parameter P₁, P₂ to the gas turbine engine 20 and, optionally, to the electric motor 28 so that the engine speed of the engine spool 36 is established at a current engine speed R_{c} greater than or equal to the idle speed Rᵣ. For example, during this step 130, the engine speed is established at the engine idle speed Rᵣ. This is typically the case when the aircraft 10 requires a minimum propulsion from the propulsion system 12, such as for example during parking on the runway or in the descent phase.

The control method 100 further comprises a step 140 of determining the current engine speed R_{c}. During this step 140, the engine control module 72 determines the current engine speed R_{c} on the basis of the command parameter or parameters P₁, P₂ that it communicates to the gas turbine engine 20 and/or to the electric motor 28 (open-loop operation), or on the basis of an item of information communicated by a sensor (not shown) of the gas turbine engine 20 (closed-loop operation).

The step 140 is followed by a step 150 of defining the maximum authorized power Pₘₐₓ. During this step, the governing system 76 defines the maximum authorized power Pₘₐₓ as a function of the current engine speed R_{c}.

In the example shown, the step 150 comprises a first sub-step 152 of computing the acceleration limit power, a second sub-step 154 of computing the overheat limit power, and a third sub-step 156 of assigning a value to the maximum authorized power Pₘₐₓ. During the first sub-step 152, the governing system 76 computes the acceleration limit power as a function of the current engine speed R_{c}. During the second sub-step 154, the governing system 76 computes the overheat limit power as a function of the current engine speed R_{c}. Finally, during the third sub-step 156, the governing system 76 assigns to the maximum authorized power Pₘₐₓ a value less than or equal to those of the acceleration limit power and of the overheat limit power. Typically, the governing system 76 assigns to the maximum authorized power Pₘₐₓ, during this sub-step 156, a value equal to the minimum of the values of the acceleration limit power and of the overheat limit power.

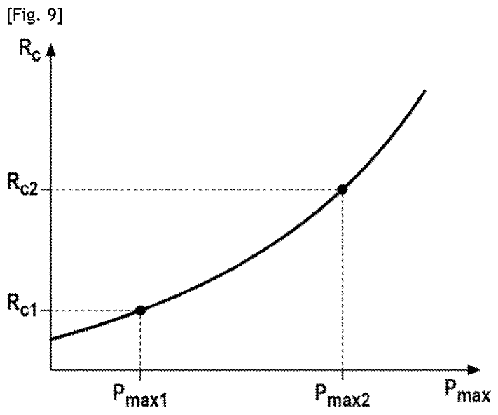

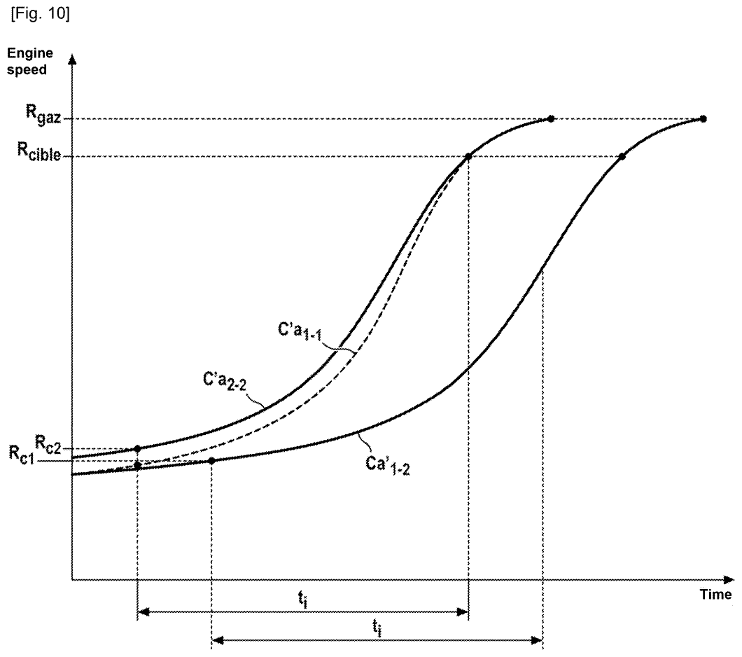

In a variant (not shown), the step 150 comprises the single sub-step 156 of assigning a value to the maximum authorized power Pmax. In this variant, the governing system 76 assigns to the maximum authorized power Pmax, during this sub-step 156, a value determined by a function parameterized in the governing system 76, said function associating with the current engine speed R_{c}, for a given flight condition, the corresponding maximum authorized power Pₘₐₓ. An example of such a function is given on FIG. 9.

As can be seen on this Figure, the maximum authorized power Pₘₐₓ tends to increase with the current engine speed R_{c}: the first maximum authorized power Pₘₐₓ₁ associated with a first current speed R_{c1} is less than the second maximum authorized power Pₘₐₓ₂ associated with a second current speed R_{c2} greater than the first current speed R_{c1}. This can be easily explained, as detailed below with reference to FIGS. 10 to 12.

FIG. 10 is a graph giving the variation over time of the engine speed of the engine spool 36 in different scenarios. The following are shown therein:
a first acceleration curve Ca′₁₋₁ of the engine spool 36 when the latter is accelerated from the first current engine speed R_{c1} at a first acceleration rate T₁,
a second acceleration curve Ca′₁₋₂ of the engine spool 36 when the latter is accelerated from the first current engine speed R_{c1} at a second acceleration rate T₂ less than the first acceleration rate T₁, and
a third acceleration curve Ca′₂₋₂ when the latter is accelerated from the second current engine speed R_{c2} at the second acceleration rate T₂.

As illustrated by the third acceleration curve Ca′₂₋₂, the second acceleration rate T₂ is enough to allow the engine spool 36 to reach the target speed R_{cible} in the allotted time tᵢ when it is accelerated from the second current speed R_{c2}. On the other hand, as illustrated by the second acceleration curve Ca′₁₋₂, this second acceleration rate T₂ is insufficient to allow the engine spool 36 to reach the target speed R_{cible} in the allotted time tᵢ when it is accelerated from the first current speed R_{c1}. As illustrated by the first acceleration curve Ca′₁₋₁, for the engine spool 36 to be able to reach the target speed R_{cible} in the allotted time tᵢ when it is accelerated from the first current speed R_{c1}, it must be accelerated at the first acceleration rate T₁.

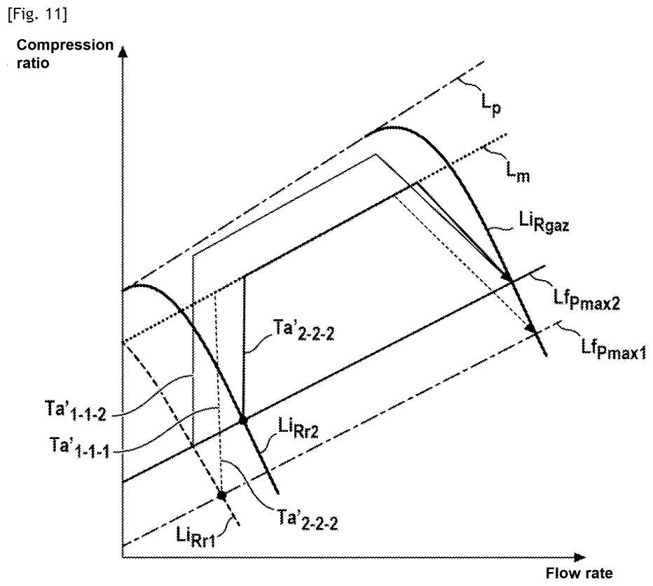

FIG. 11 is a flow rate/compression ratio graph showing the characteristic curves of the high-pressure compressor 40 of the gas turbine engine 20 in different scenarios. The following are shown therein:
the surge line Lp of the high-pressure compressor 40;
the margin line Lm of the high-pressure compressor 40;
the operating lines Lf_{Pmax1} and Lf_{Pmax2} of the high-pressure compressor 40 when the electrical power generated by the rotary machine 22 is equal, respectively, to the first maximum authorized power Pₘₐₓ₁ and to the second maximum authorized power Pₘₐₓ₂;
the isospeed lines Li_{Rc1}, Li_{Rc2} and Li_{Rgaz} of the high-pressure compressor 40 at the first current engine speed R_{c1}, at the second current engine speed R_{c2} and at the full-throttle speed R_{gaz}; and
the acceleration transient curves Ta′₁₋₁₋₁, Ta′₁₋₁₋₂ and Ta′₂₋₂₋₂ showing the variation in the compression ratios as a function of the flow rate when the engine spool 36 is respectively accelerated:
   from the first current engine speed R_{c1}, at the first acceleration rate T₁ while the electrical power generated by the rotary machine 22 is equal to the first maximum authorized power Pₘₐₓ₁,
   from the first current engine speed R_{c1}, at the first acceleration rate T₁ while the electrical power generated by the rotary machine 22 is equal to the second maximum authorized power Pₘₐₓ₂, and
   from the second current engine speed R_{c2}, at the second acceleration rate T₂ while the electrical power generated by the rotary machine 22 is equal to the second maximum authorized power Pₘₐₓ₂.

As illustrated by the acceleration transient curve Ta′₂₋₂₋₂, when the engine spool 36 is accelerated at the second acceleration rate T₂ from the second current speed R_{c2} while the electrical power generated by the rotary machine 22 is equal to the second maximum authorized power Pₘₐₓ₂, the compression ratio of the high-pressure compressor 40 remains beyond the margin line Lm: the compressor 40 thus does not present any stalling risk. On the other hand, as illustrated by the acceleration transient curve Ta′₁₋₁₋₂, if one wishes to accelerate the engine spool 36 at the first acceleration rate T₁ from the first current speed R_{c1} while the electrical power generated by the rotary machine 22 is still equal to the second maximum authorized power Pₘₐₓ₂, the compression ratio of the high-pressure compressor 40 crosses the margin line Lm: this entails an excessive risk of stalling of the high-pressure compressor 40, so it is unacceptable to keep the maximum authorized power at the value Pₘₐₓ₂ when the first acceleration rate T₁ is applied. To be able to apply this first acceleration rate T₁ and thus allow the engine spool 36 to reach the target speed R_{cible} in the allotted time tᵢ when it is accelerated from the first current speed R_{c1} while the electrical power generated by the rotary machine 22 is equal to the maximum authorized power Pₘₐₓ, this maximum authorized power Pₘₐₓ must be reduced to a lower value Pₘₐₓ₁, as illustrated by the acceleration transient curve Ta′ ₁₋₁₋₁.

The first maximum authorized power Pₘₐₓ₁ must therefore be less than the second maximum authorized power Pₘₐₓ₂ to allow the engine spool 36 to reach the target speed R_{cible} in the allotted time tᵢ without stalling when the engine spool 36 is rotating at the first current engine speed R_{c1}.

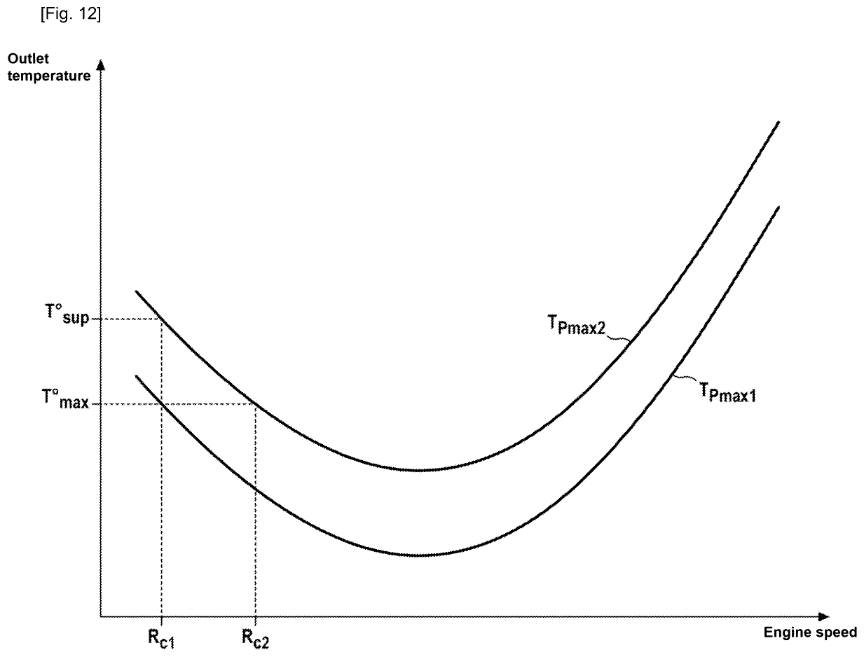

Another reason for which the first maximum authorized power Pₘₐₓ₁ is less than the second maximum authorized power Pₘₐₓ₂ is illustrated by FIG. 12. This Figure is a graph giving the relationship between the engine speed of the engine spool 36 and the temperature at the outlet of the gas turbine engine 20 in different scenarios. The following are shown therein:
a first temperature curve T_{Pmax1} of the outlet of the gas turbine engine 20 when the electrical power generated by the rotary machine 22 is equal to the first maximum authorized power Pₘₐₓ₁, and
a second temperature curve T_{Pmax2} of the outlet of the gas turbine engine 20 when the electrical power generated by the rotary machine 22 is equal to the second maximum authorized power Pₘₐₓ₂.

As can be seen on FIG. 12, the first and second temperature curves T_{Pmax1}, T_{Pmax2} each have a U-shaped profile, the range of variation of the current engine speed R_{c} lying in the region of the graph in which these curves are decreasing. In addition, the second current engine speed R_{c2} is such that the engine spool 36 rotates at said second current engine speed R_{c2} while the electrical power generated by the rotary machine 22 is equal to the second maximum authorized power Pₘₐₓ₂, the temperature at the outlet of the gas turbine engine 20 is equal to the maximum temperature T°ₘₐₓ. Finally, the second temperature curve T_{Pmax2} is logically located above the first temperature curve T_{Pmax1}, insofar as the supply of the rotary machine 22 with mechanical energy requires, for equal engine speed, the burning of more combustive substances in the combustion chamber 34. This entails that if the rotary machine 22 could generate the second maximum authorized power Pₘₐₓ₂ when the engine spool 36 is rotating at the first current engine speed R_{c1}, the temperature at the outlet of the gas turbine engine 20 would then be at a value T°ₛᵤₚ greater than the maximum temperature T°ₘₐₓ. To avoid this, the maximum authorized power Pₘₐₓ when the engine spool 36 is rotating at the first current engine speed R_{c1} is set to a lower value Pₘₐₓ₂, said value consisting of the greatest generated electrical power for which the temperature at the outlet of the gas turbine engine 20 is less than or equal to the maximum temperature T°ₘₐₓ when the engine spool 36 is rotating at the first current engine speed R_{c1}.

It can easily be seen that the curves of FIGS. 5 and 9 are superimposed. The curve giving the maximum authorized power Pmax as a function of the current speed R_{c} is therefore the reciprocal of the curve giving the idle speed Rᵣ as a function of the current power P_{c}. This means that when the engine speed is established at the idle speed Rᵣ, or in other words when the idle speed Rᵣ constitutes the current engine speed R_{c}, as in the example detailed here, then the current electrical power P_{c} constitutes the maximum authorized power Pₘₐₓ.

The step 150 is followed by a step 160 of limiting the generated electrical power to the maximum authorized power Pₘₐₓ. During this step 150, the command module 74 limits the electrical power generated by the rotary machine 22 to the maximum authorized power Pₘₐₓ. In particular, the command module 74 commands the rotary machine 22 such that the current electrical power P_{c} generated by this latter is equal to the power Pₘₐₓ or, if the latter are lower, to the current electrical power requirements of the aircraft 10 reflected by the item of information I_{c}. The command module 74 applies this limitation while the engine spool 36 is rotating at the current engine speed R_{c} and during any subsequent acceleration phase, until the engine speed stabilizes at a new value.

The control method 100 further comprises, following the step 160, a step 170 of controlling the variations in the electrical power generated by the rotary machine 22. These power variations are capped at the maximum authorized power Pₘₐₓ. If the generated electrical power varies, the control method 100 returns to the step 110. Otherwise, the control method 100 continues.

According to a first variant in continuation of the control method 100, the step following on from the step 170 is a step 180 of increasing the thrust setpoint Cₚ. During this step 180, the engine control module 72 receives from the aircraft 10 an increased thrust setpoint Cₚ. This step 180 is followed by a step 182 of acceleration of the engine spool 36 which will be detailed below.

According to a second variation in continuation of the control method 100, the step following on from step 170 is a step 190 of deducing a future requirement of the aircraft 10. During this step 190, the managing system 78 receives from the aircraft 10 an item of information I_{f} representative of a future electrical power requirement of the aircraft 10 and deduces from this item of information I_{f} the future electrical power requirement of the aircraft 10.

Step 190 is followed by a step 192 of comparing said future requirement with the current electrical power P_{c}. During this step 192, the managing system 78 compares the future requirement reflected by the item of information If with the current electrical power P_{c}. If this future requirement is less than or equal to the current electrical power P_{c}, the method returns to the step 160. Contrariwise, if the future requirement is greater than the current electrical power P_{c}, the step 192 is followed by a step 194 of modifying the idle speed Rᵣ so that it meets the future requirement.

During the step 194, the managing system 78 modifies the idle speed Rᵣ as a function of the future requirement reflected by the item of information I_{f}. For this purpose, the managing system 78 computes, for example, a future acceleration limit speed and a future overheat limit speed as a function of said future requirement, and assigns to the idle speed Rᵣ a new value greater than or equal to those of the future acceleration limit speed and of the future overheat limit speed, typically equal to the maximum of the two future limit speeds. In a variant, the managing system 78 assigns to the idle speed Rᵣ a new value determined by the function associating with the current electrical power P_{c} the corresponding idle speed Rᵣ parameterized in the managing system 78 (FIG. 5). Then the managing system 78 communicates this new value to the engine control module 72.

The step 194 is followed by a step 196 of comparing the new value of the idle speed R with the current engine speed R_{c}. During this step 196, the engine control module 72 compares the new value of the idle speed Rᵣ received from the managing system 78 with the current engine speed R_{c}. If this new value is less than or equal to the current engine speed R_{c}, the method 100 returns to the step 130. Contrariwise, if the new value is greater than the current engine speed R_{c}, the step 196 is followed by the step 182 of accelerating the engine spool 36.

During the step 182, the engine control module 72 sends to the gas turbine engine 20 at least one command parameter P₁ suitable for the engine spool 36 to accelerate. The engine spool 36 then accelerates from the current engine speed R_{c}, while the rotary machine 22 is generating an electrical power less than or equal to the maximum authorized power Pₘₐₓ, until a new current engine speed R_{c} is reached.

If the step 182 follows on from the step 196, the new current speed R_{c} consists of a new engine idle speed Rᵣ.

If the step 182 follows on from the step 180 and if the increased command parameter Cₚ consists of a full-throttle thrust setpoint, the acceleration is done at the maximum acceleration rate Tₘₐₓ. The current engine speed R_{c} being greater than or equal to the idle speed Rᵣ and the electrical power generated by the rotary machine 22 being capped at the maximum authorized power Pₘₐₓ, the engine spool 36 then reaches, without stalling, the target speed R_{cible} in the allotted time tᵢ.

Note that the maximum authorized power Pₘₐₓ is a function of the current speed R_{c} before the start of the step 180 and is not updated during the step 182, i.e. during the entire acceleration phase 182, the maximum authorized power Pₘₐₓ remains constant at a value depending on the current speed R_{c} before acceleration.

The control method 100 then returns to the step 130.

Optionally, the step 182 includes a sub-step 184 of injection of power by the electric motor 28. During this step 184, the engine control module 72 sends to the electric motor 28 at least one command parameter P₂ suitable for increasing the torque of the electric motor 28. Thus the electric motor 28 injects mechanical energy onto the high-pressure shaft 44 and contributes to the acceleration of the engine spool 36. This makes it possible to increase the maximum acceleration rate Tₘₐₓ for a given generated electrical power. Hence, the engine idle speed Rᵣ associated with a given current power P_{c} can be lowered and the maximum electrical power Pₘₐₓ associated with a current engine speed R_{c} can be increased.

Owing to the exemplary embodiment described above, the engine idle speed Rᵣ can be modulated as a function of the electrical power actually generated by the rotary machine 22. It is therefore possible to lower the engine idle speed Rᵣ to below the necessary minimum engine speed to tolerate the maximum electrical power that can be generated by the rotary machine 22. The thrust of the propulsion system 12 in idle can therefore be reduced. This makes it possible to maintain the ratio of the drag of the aircraft 10 to the thrust of the propulsion system 12 at the engine idle speed at a high enough value for the descent gradient of the aircraft 10 not to be too low. Thus, it is not necessary to perform descent maneuvers to break the lift of the airplane or increase its drag, which makes it possible to save on fuel. Similarly, on the ground, the reduction of the engine idle speed Rᵣ makes it possible to reduce wear on the brakes of the aircraft 10.

1. An aircraft propulsion system comprising:
a gas turbine engine with a combustion chamber and an engine spool, the engine spool including a turbine downstream of the combustion chamber, a compressor upstream of the combustion chamber and a transmission shaft for driving the compressor via the turbine;
a control system;
a member for determining a current engine speed of the engine spool; and
a rotary machine coupled to the transmission shaft for generating electrical power by taking off mechanical power from the transmission shaft,
wherein the control system is configured to limit a current electrical power generated by the rotary machine at least when the engine spool is in the acceleration phase, to a maximum authorized power, the maximum authorized power being function of the current engine speed before acceleration, and
wherein the propulsion system comprises a device for determining the current electrical power generated by the rotary machine, the control system being configured to establish the engine speed above an idle speed which is a function of the current electrical power.

2. The propulsion system as claimed in claim 1, comprising a system for deducing a future requirement of the aircraft for electrical power generated by the rotary machine, the control system being configured to accelerate the engine spool when said future requirement is greater than the maximum authorized power.

3. The propulsion system as claimed in claim 1, wherein, when the engine speed is established at the idle speed, the current electrical power constitutes the maximum authorized power.

4. The propulsion system as claimed in claim 1, wherein the idle speed is greater than or equal to an acceleration limit speed for which the engine spool, accelerating to the stall limit from said acceleration limit speed while the rotary machine is generating the current electrical power, reaches without stalling, in an allotted time less than or equal to 10 seconds, a target speed at which the gas turbine engine produces a substantial percentage of a full-throttle thrust.

5. The propulsion system as claimed in claim 1, wherein the idle speed is greater than or equal to an overheat limit speed for which, when the engine spool is rotating at said overheat limit speed while the rotary machine is generating the current electrical power, the temperature of the gas at the outlet of the gas turbine engine is equal to a predetermined maximum temperature.

6. The propulsion system as claimed in claim 4, wherein the idle speed is equal to the maximum of the acceleration limit speed and of the overheat limit speed.

7. The propulsion system as claimed in claim 1, wherein the maximum authorized power is less than or equal to an acceleration limit power for which the engine spool, accelerating to the stall limit from the current engine speed while the rotary machine is generating said acceleration limit power, reaches without stalling, in an allotted time less than or equal to 10 seconds, a target speed at which the gas turbine engine produces a substantial percentage of a full-throttle thrust.

8. The propulsion system as claimed in claim 1, wherein the maximum authorized power is less than or equal to an overheat limit power for which, when the engine spool is rotating at the current speed while the rotary machine is generating said overheat limit power, the temperature of the gas at the outlet of the gas turbine engine is equal to a predetermined maximum temperature.

9. The propulsion system as claimed in claim 7, wherein the maximum authorized power is equal to the minimum of the acceleration limit power and the overheat limit power.

10. The propulsion system as claimed in claim 1, wherein the control system is configured to limit the electrical power generated by the rotary machine when the engine spool is not in the acceleration phase.

11. A control method for controlling an aircraft propulsion system comprising a gas turbine engine with a combustion chamber and an engine spool, the engine spool including a turbine downstream of the combustion chamber, a compressor upstream of the combustion chamber and a transmission shaft for driving the compressor via the turbine, and rotary machine coupled to the transmission shaft for generating electrical power by taking off mechanical power from the transmission shaft, the control method comprising the following successive steps:
determining a current electrical power generated by the rotary machine,
defining an idle speed which is a function of the current electrical power,
establishing the engine speed above the idle speed,
determining a current engine speed of the engine spool,
defining a maximum authorized power which is a function of the current engine speed, and
accelerating the engine spool, the current electrical power generated by the rotary machine being limited to the maximum authorized power.
